(19) United States
(12) Patent Application Publication
(10) Pub. No.: US 2026/0323515 A1
(43) Pub. Date: Oct. 15, 2026

(54) PRIORITIZED REALLOCATION AFTER EARLY TERMINATION OF A SERVICE PERIOD

(71) Applicant: NEWRACOM, Inc., Irvine, CA (US)

(72) Inventors: Jaehyuk CHOI, Seongnam (KR); Joonsoo LEE, Irvine, CA (US)

(73) Assignee: NEWRACOM, Inc., Irvine, CA (US)

(21) Appl. No.: 19/630,089

(22) Filed: Mar. 26, 2026

Related U.S. Application Data
(60) Provisional application No. 63/787,611, filed on Apr. 11, 2025.

(51) Int. Cl. H04W 52/02; H04W 72/04

(52) U.S. Cl. CPC H04W 52/0225; H04W 72/04

(57) ABSTRACT

A method that is performed by a station (STA) that is not a member of a service period of a scheduled power saving scheme to receive channel access priority if the service period is terminated early. The method includes prior to a start of the service period, transmitting a first frame to an access point (AP) that carries an early termination priority request indication, being in an awake state during the service period despite not being a member of the service period, receiving a trigger frame from the AP before a scheduled end time of the service period due to early termination of the service period, and responsive to receiving the trigger frame, transmitting a second frame to the AP.

### CROSS-REFERENCE TO RELATED APPLICATION

This application claims the benefit of U.S. Provisional Application No. 63/787,611, filed Apr. 11, 2025, titled “Prioritized Reallocation After Restricted Target Wake Time Early Termination”, which is hereby incorporated by reference.

### TECHNICAL FIELD

The present disclosure generally relates to wireless communications, and more specifically, relates to a prioritized reallocation mechanism to reallocate the remaining duration of a service period when the service period is terminated early.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

Restricted target wake time (r-TWT) is a feature defined in the IEEE 802.11 wireless networking standards that provides strict medium access scheduling for time-sensitive traffic by scheduling service periods (SPs) for designated member stations (STAs). This feature significantly improves latency predictability and minimizes contention, providing reliable support for real-time and high-priority applications.

Existing r-TWT mechanisms allow a SP to be terminated early (before its scheduled end time) when all participating member STAs have completed their transmissions. In such cases, the r-TWT scheduling access point (AP) may announce the early termination of the SP and release the channel for general access. Subsequently, the wireless medium may revert to a contention-based access state that allows non-member STAs to compete for transmission opportunities (e.g., using carrier sense multiple access with collision avoidance (CSMA/CA)).

The existing early termination approach suffers from several drawbacks. First, non-member STAs may remain in a doze state during the r-TWT SP to conserve energy and thus may miss the early termination signal, resulting in the underutilization of the remaining SP duration. Second, even if STAs are able to hear the early termination signal, the sudden switch from a strictly scheduled environment to an open contention environment can result in inefficient medium access, particularly in dense or latency-sensitive wireless networks.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a wireless network environment that can implement r-TWT, according to some embodiments.

FIG. 11 is a diagram showing a restricted target wake time (r-TWT) frame exchange sequence, according to some embodiments.

FIG. 12 is a diagram showing the early termination of a r-TWT service period (SP), according to some embodiments.

FIG. 13 is a diagram showing a frame exchange sequence where a non-member station (STA) and a legacy STA access the channel after a SP is terminated early, according to some embodiments.

FIG. 14 is a diagram showing a frame exchange sequence for selectively reallocating the remaining duration of a SP after it has been terminated early, according to some embodiments.

FIG. 15 is a diagram showing an architecture for implementing prioritized reallocation, according to some embodiments.

FIG. 16 is a flow diagram of an early termination priority access method that can be implemented by a non-member STA, according to some embodiments.

FIG. 17 is a diagram showing a signaling sequence for implementing a prioritized reallocation mechanism, according to some embodiments.

FIG. 18 is a diagram showing a media access control (MAC) frame format, according to some embodiments.

FIG. 19 is a flow diagram of a method for requesting channel access priority if a service period of a scheduled power saving scheme is terminated early, according to some embodiments.

FIG. 20 is a flow diagram of a method for giving channel access priority to a non-member STA of a service period of a scheduled power saving scheme when the service period is terminated early, according to some embodiments.

### DETAILED DESCRIPTION

The present disclosure generally relates to wireless communications, and more specifically, relates to a prioritized reallocation mechanism to reallocate the remaining duration of a service period when the service period is terminated early.

As mentioned earlier, the existing restricted target wake time (r-TWT) early termination approach suffers from several drawbacks. First, non-member STAs may remain in a doze state during the r-TWT SP to conserve energy and thus may miss the early termination signal, resulting in the underutilization of the remaining SP duration. Second, even if STAs are able to hear the early termination signal, the sudden switch from a strictly scheduled environment to an open contention environment can result in inefficient medium access, particularly in dense or latency-sensitive wireless networks.

The existing r-TWT mechanisms do not provide a way for an access point (AP) (or other r-TWT scheduling entity) to reclaim and reallocate the unused portion of the SP based on traffic demand, scheduling priority, or station capability. This absence of a prioritized reallocation mechanism prevents the wireless network from fully leveraging the remaining duration in the SP (when the SP is terminated early), thereby limiting overall channel efficiency and quality of service (QoS) assurances.

The present disclosure describes a prioritized reallocation mechanism that allows the AP (or other scheduling entity) to reallocate the remaining duration of a SP to non-member STA(s) in the event that the SP is terminated early. The prioritized reallocation mechanism may provide a signaling protocol that can enhance the flexibility and efficiency of SP management in next-generation wireless networks. Specifically, the mechanism may address the problem of underutilized airtime that results from early termination of a SP.

With existing r-TWT early termination approaches, when all member STAs of the SP complete their transmissions before the scheduled end time of the SP, the r-TWT scheduling AP typically releases the remaining airtime for general contention-based access, allowing non-member STAs to contend for the channel using carrier sense multiple access with collision avoidance (CSMA/CA). However, this can result in inefficient channel usage, particularly if non-member STAs are in the doze state or fail to detect the early termination signal.

To overcome this limitation of existing approaches, the prioritized reallocation mechanism disclosed herein allows the AP to retain control over the remaining airtime following early termination of a SP. Rather than releasing the channel immediately, the AP may selectively reallocate the remaining duration of the SP to one or more non-member STAs by transmitting a dedicated control frame (e.g., trigger frame) to the one or more non-member STAs. The non-member STAs may remain in the awake state during the SP (e.g., enabled by dynamic power save (DPS) low-capacity (LC) monitoring) in anticipation of potential reallocation, and upon receiving the control frame, they may promptly initiate transmission during the remaining duration of the SP.

In addition, to allow STAs to proactively express their need for prioritized access, the prioritized reallocation mechanism may provide an early termination priority request (ETPR) mechanism. A non-member STA anticipating r-TWT interruption of its ongoing transmission opportunity (TXOP) may transmit a quality of service (QoS) null frame or power save poll (PS-Poll) frame (or similar frame) that includes an ETPR indication (e.g., which can be encoded using a reserved bit within a QoS control field) before the start of the SP. The AP may interpret the ETPR indication as a request for prioritized channel access upon early SP termination and respond with an acceptance or denial indication (e.g., via a block acknowledgement (BA) frame or other type of acknowledgement frame). If the request is accepted, the requesting STA may remain in the awake state during the SP and become eligible for prioritized reallocation if the SP is terminated early.

To further enhance transparency and system responsiveness, the prioritized reallocation mechanism described herein may provide a mechanism that allows the AP to explicitly indicate, at the start of each SP, whether early termination is enabled for the SP and whether reallocation of residual airtime will be performed. This signaling enables non-member STAs to adjust their behavior accordingly, either by preparing for prioritized reallocation or by transitioning to a power-saving mode if contention-based access is expected.

The prioritized reallocation mechanism described herein may provide a structured and policy-driven reallocation framework for handling early-terminated SPs. The mechanism may increase channel utilization, support differentiated service for latency-sensitive traffic, and maintain backward compatibility with legacy STAs. By combining trigger-based reallocation, dynamic power-saving strategies, and a lightweight ETPR signaling procedure, the mechanism may provide a scalable and standards-aligned enhancement for wireless networks.

With existing r-TWT mechanisms, when a r-TWT SP ends earlier than its scheduled end time, the remaining airtime is typically released for general contention using CSMA/CA mechanisms. This can result in suboptimal channel utilization, particularly if non-member STAs are unaware of the early termination or unable to respond promptly. In contrast, the prioritized reallocation mechanism described herein allows the AP to retain control over the remaining airtime and selectively reallocate it to one or more preselected non-member STAs (e.g., to a non-member STA that has requested channel access priority via ETPR signaling). This enables a more structured and policy-driven use of the channel resources.

STAs that have deferred transmissions or require rapid uplink access may proactively request channel access priority by transmitting a QoS data frame with the ETPR bit/flag set to a particular state (e.g., binary “1”) in the QoS control field to request prioritized channel access. If the request is accepted, the STA may be given prioritized channel access upon the occurrence of an early termination event (when the SP is terminated early), which allows the STA to transmit latency-sensitive or urgent data in a reliable and timely manner.

The prioritized reallocation mechanism described herein may be designed to be backward compatible and align with existing wireless networking standards (e.g., IEEE 802.11 wireless networking standards) by using familiar signaling frames/formats such as QoS data frames, BA frames, and trigger frames. This allows for the mechanism to be seamlessly integrated into existing wireless network architectures with minimal protocol overhead and alterations.

The prioritized reallocation mechanism described herein may help improve fairness and efficiency with regard to the allocation of residual airtime, while also supporting improved QoS for applications having time-sensitive or urgent communication needs.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

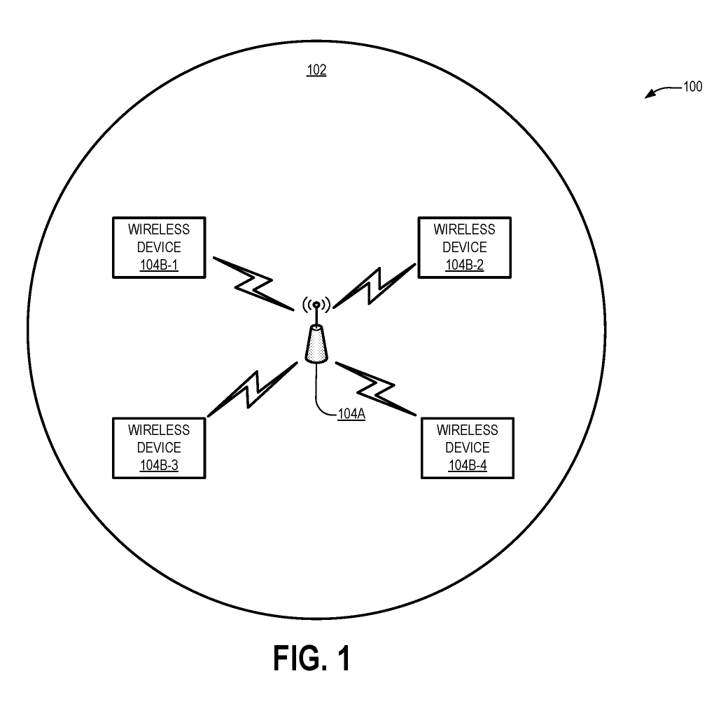

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

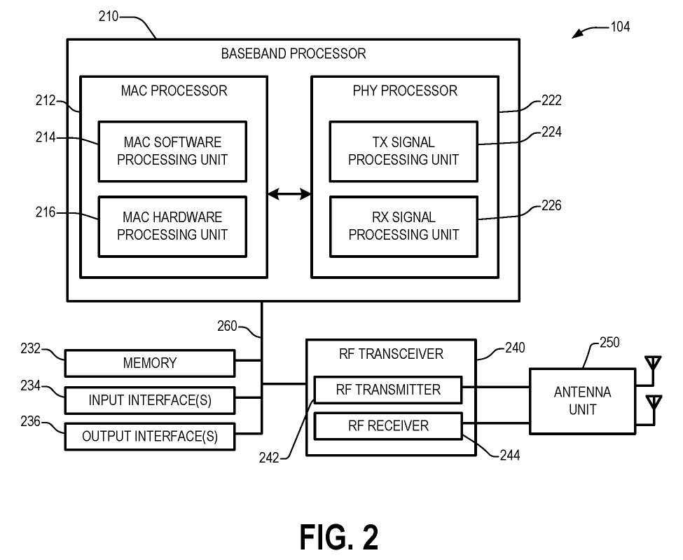

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

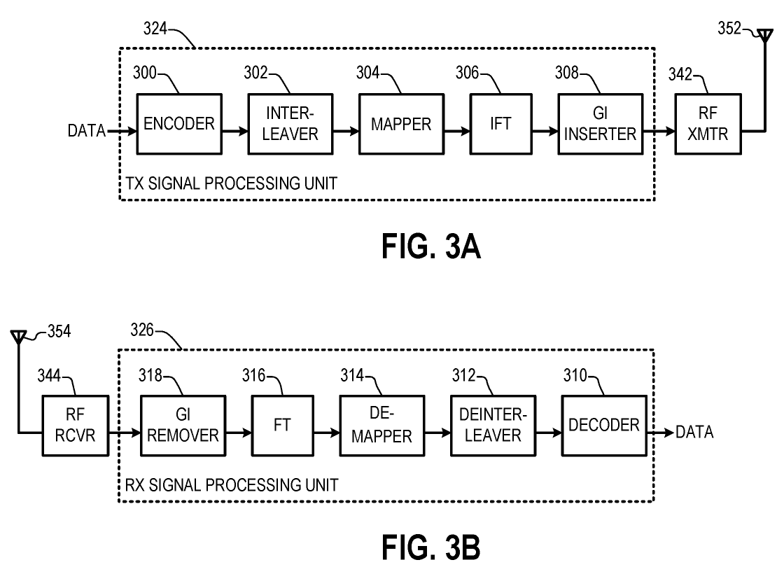

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

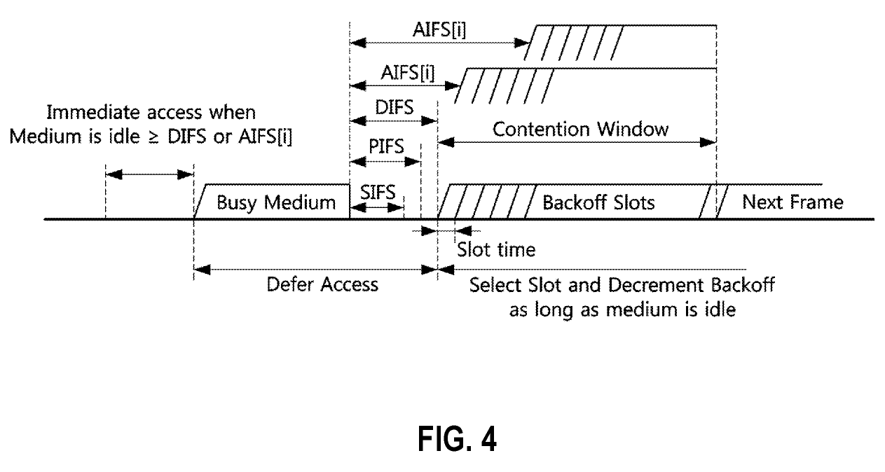

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

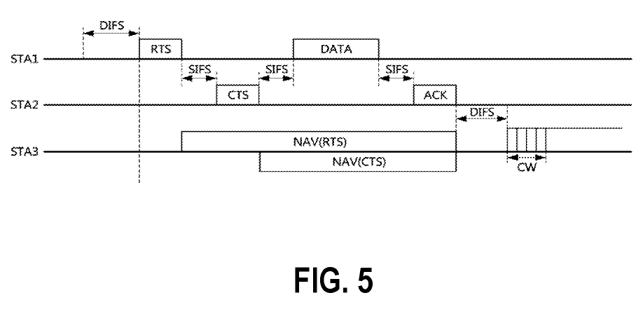

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS + CTS frame duration + SIFS + data frame duration + SIFS + ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

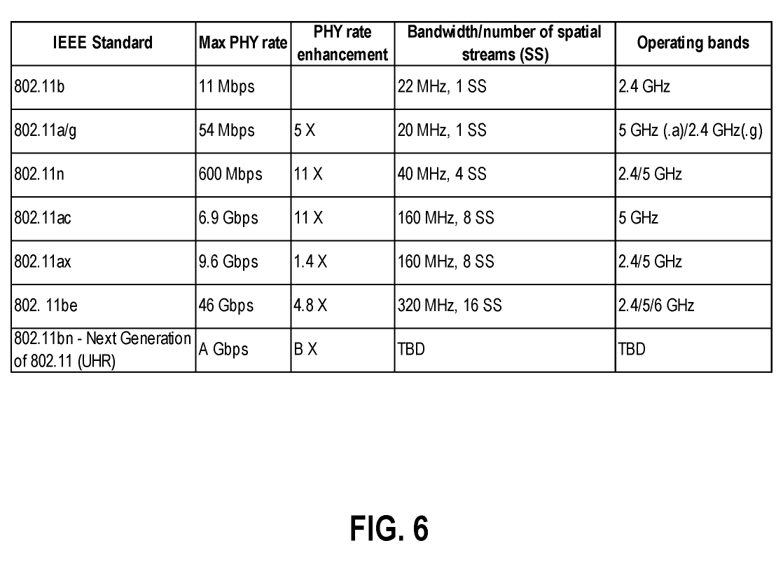

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925– 7.125 GHz) is being considered for unlicensed use. This would allow APs and STAs to become tri-band devices. Larger than 160MHz data transmissions (e.g., 320 MHz or 640 MHz) could be considered to increase the maximum PHY rate. For example, 320 MHz or 160+160MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

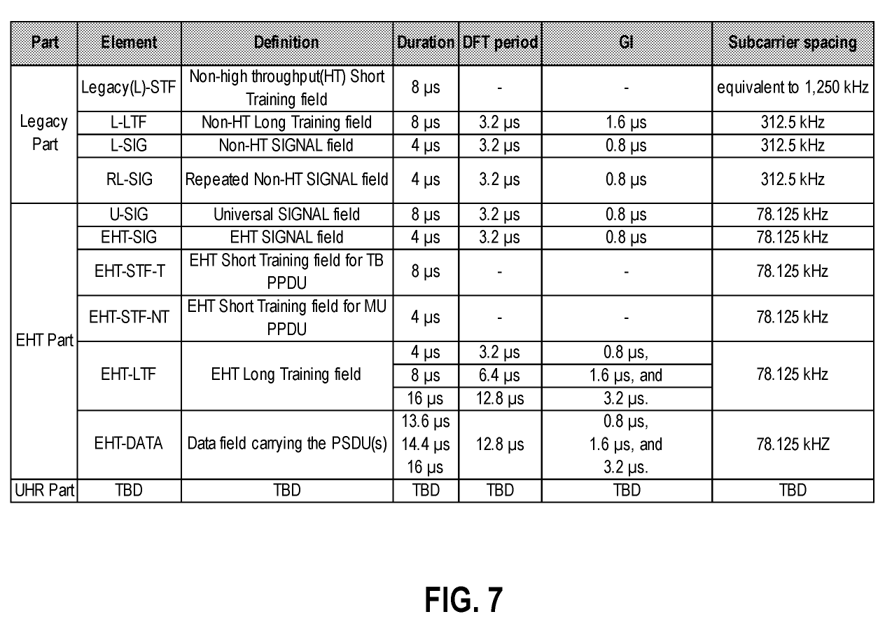

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

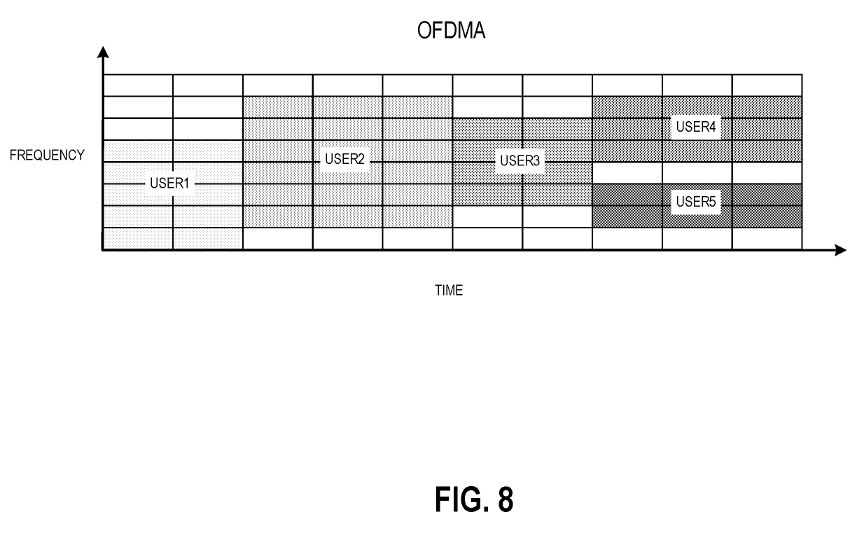

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

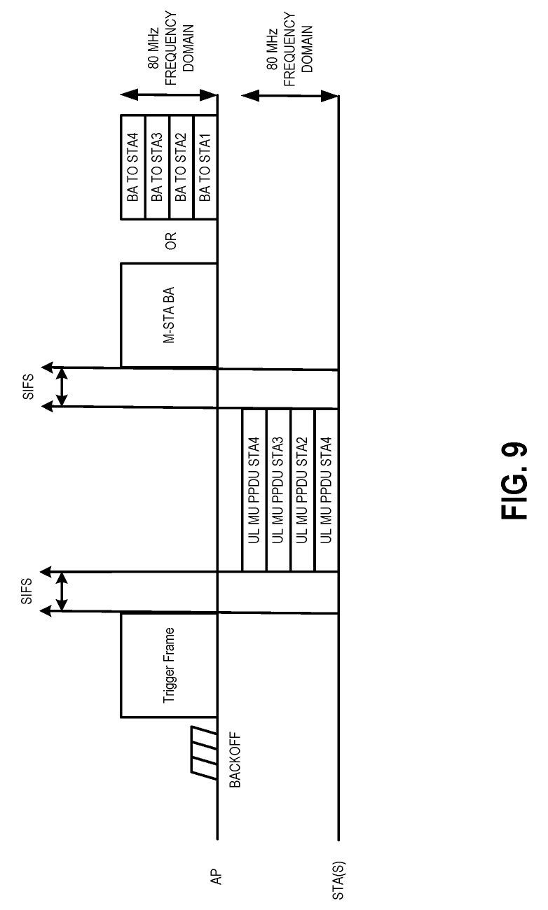

FIG. 9 illustrates an example scenario where an access point (AP) operating in an 80MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

As used herein, a scheduled power saving scheme is a type of scheme that enables devices to transition between an awake state and a doze state according to a predefined or negotiated schedule (e.g., having scheduled wake-up times and wake durations). TWT is an example of a scheduled power saving scheme. As used herein, a dynamic power saving scheme is a type of scheme that allows devices to switch between different power consumption modes (e.g., between a high capability mode and a low capability mode) on demand (e.g., via signaling). DPS (dynamic power save) is an example of a dynamic power saving scheme.

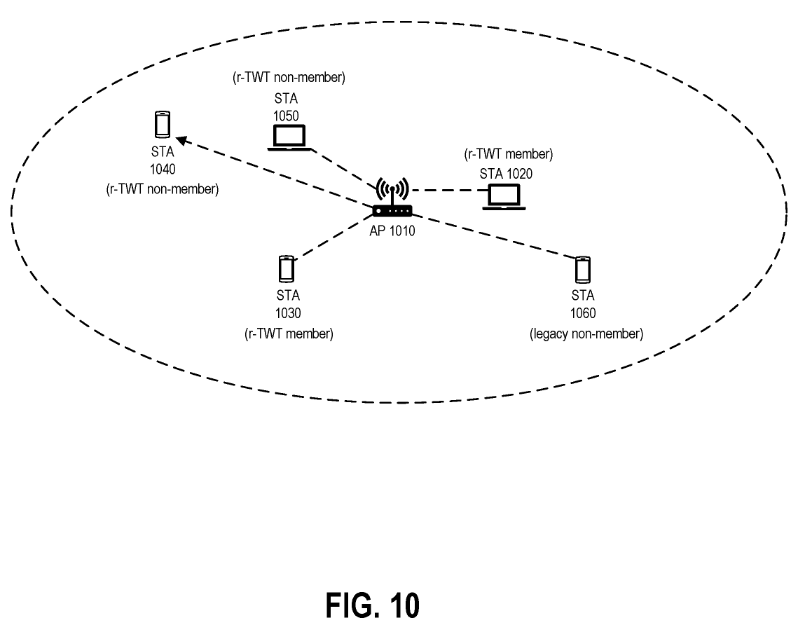

FIG. 10 is a diagram showing a wireless network environment that can implement r-TWT, according to some embodiments.

As shown in the diagram, the wireless network environment may include an AP 1010 and five non-AP STAs that are associated with the AP (STA 1020, STA 1030, STA 1040, STA 1050, and STA 1060). The STAs may be implemented by any type of wireless device such as a mobile device, IoT device, or the like.

Each STA may support r-TWT or a similar scheduled power saving scheme. For sake of explanation, it is assumed that the STAs support r-TWT. The use of r-TWT may support power-efficient and latency-aware communications.

In this example, it is assumed that the AP 1010 can manage and schedule a r-TWT SP that is reserved exclusively for member STAs participating in the scheduled r-TWT session. In this example, it is assumed that STA 1020 and 1030 are members of the SP, and thus have exclusive access to the channel during the scheduled time window of the SP. Also, in this example, it is assumed that the remaining STAs (STA 1040, STA 1050, and STA 1060) are not members of the SP. Among the non-member STAs, STA 1040 and STA 1050 may be non-member STAs that are capable of recognizing the r-TWT session via beacon frames or other scheduling signals, and thus may be categorized as “r-TWT scheduled STAs.” In contrast, STA 1060 may represent a legacy device without r-TWT or dynamic power save (DPS) capability. Thus, STA 1060 may only operate in conventional power modes and may not be able to take advantage of advanced scheduling and power-saving mechanisms described herein.

As will be described herein, a prioritized reallocation mechanism may be implemented in the wireless network environment to selectively reallocate the remaining duration of a r-TWT SP when the SP is terminated early.

For sake of explanation only, various embodiments may be described herein in the context of the wireless network environment shown in FIG. 10. It should be appreciated, however, that the techniques and concepts described herein may be applicable to other wireless network environments having different configurations.

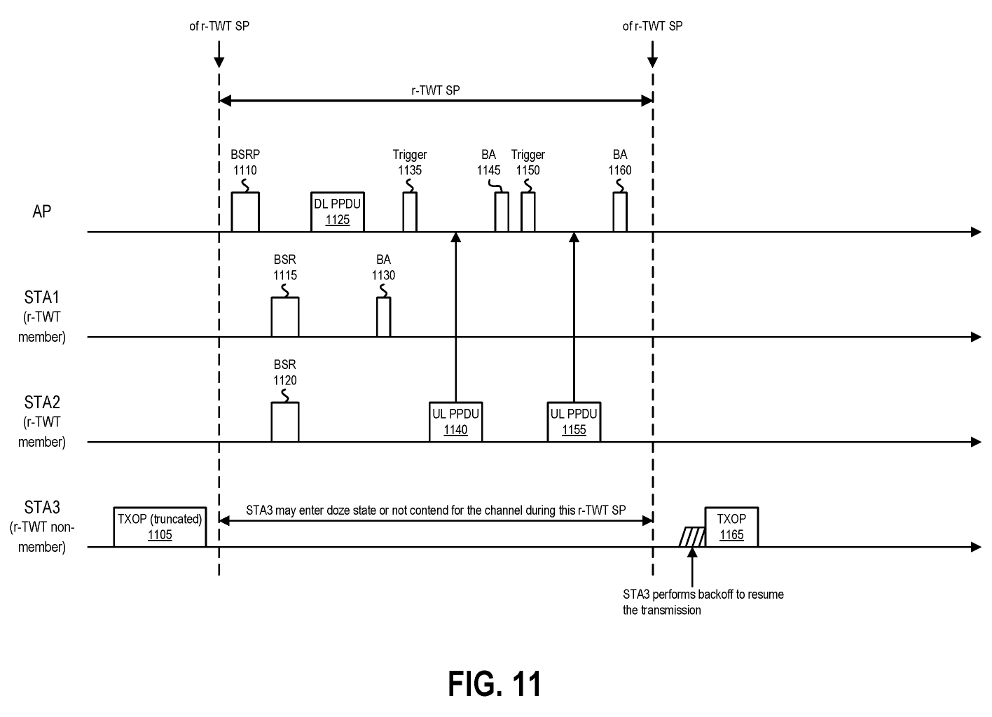

FIG. 11 is a diagram showing a r-TWT frame exchange sequence, according to some embodiments.

In the example shown in the diagram, the AP may act as the r-TWT scheduling entity that is responsible for scheduling, coordinating, and managing a r-TWT SP for participating member STAs. Also, in this example, it is assumed that STA1 and STA2 are members of the SP, but STA3 is not a member of the SP.

During the SP, the AP may facilitate prioritized communication exchanges with the member STAs. For example, during the SP, the AP may transmit buffer status report poll (BSRP) frame 1110 to STA1 and STA2. STA1 and STA2 may transmit buffer status report (BSR) frame 1115 and BSR frame 1120, respectively, to the AP. The AP may then transmit downlink physical layer protocol data unit (DL PPDU) 1125 to STA1 and STA1 may respond by transmitting block acknowledgement (BA) frame 1130 to the AP. The AP may then transmit trigger frame 1135 to STA2 to solicit uplink transmission from STA2. Responsive to receiving trigger frame 1135, STA2 may transmit uplink physical layer protocol data unit (UL PPDU) 1140 to the AP and the AP may respond by transmitting BA frame 1145 to STA2. The AP may then transmit another trigger frame 1150 to STA2 to solicit another uplink transmission from STA2. Responsive to receiving trigger frame 1150, STA2 may transmit UL PPDU 1155 to the AP and the AP may respond by transmitting BA frame 1160 to STA2.

STA3, which is a non-member STA of the SP, may be capable of recognizing the existence of the SP via beacon frames or other scheduling signals, and may be considered to be a r-TWT scheduled STA. STA3 is not permitted to participate in the SP and is required to end any ongoing transmissions or transmission opportunity (TXOP) 1105 prior to the start of the SP. This ensures that the SP remains exclusively available to the member STAs. When the SP ends, STA3 (which had to pause its transmission/TXOP before the start of the SP) may attempt to resume its transmission by contending for the channel using channel access mechanisms such as random backoff. In this example, STA3 is able to resume transmission during TXOP 1165 after the SP ends.

To ensure strict channel isolation during the SP, the AP may broadcast a quiet element that explicitly defines a time period during which all receiving STAs (e.g., non-member STAs such as STA3) must remain silent. Upon receiving the quiet element, non-member STAs may transition to a quiet mode or refrain from initiating any new transmissions throughout the duration of the SP to prevent channel contention and ensure that the SP can provide interference-free channel access for the member STAs.

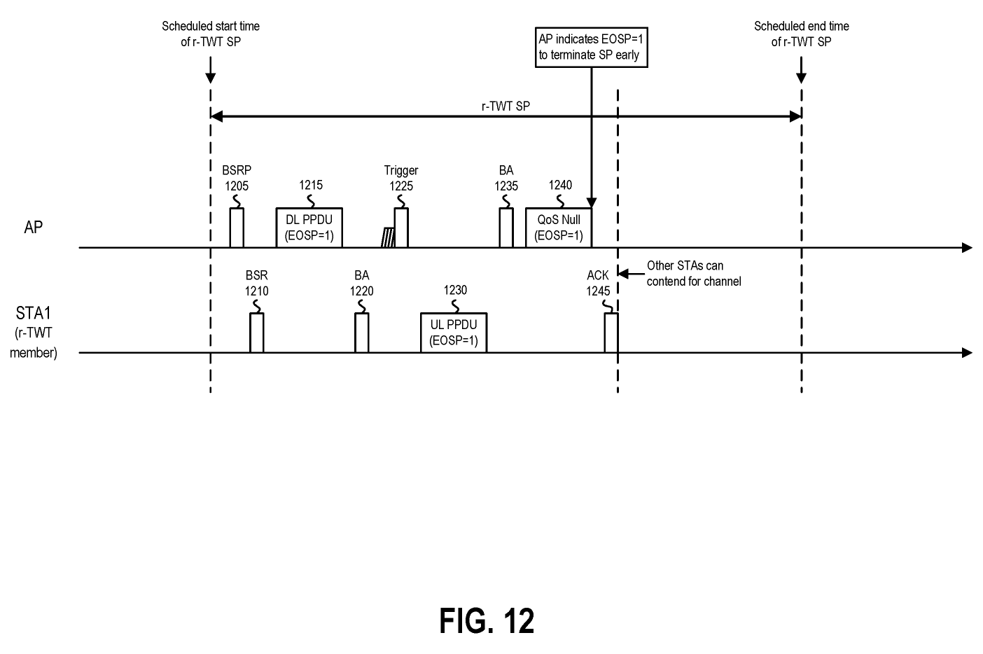

FIG. 12 is a diagram showing the early termination of a r-TWT SP, according to some embodiments. The diagram shows an example of how a r-TWT scheduling AP can terminate a r-TWT SP early by transmitting a QoS null frame 1140 that includes an early termination indication.

In the example shown in the diagram, the AP and STA1 participate in the r-TWT SP (STA1 is a member of the SP in this example). During the SP, the AP may transmit BSRP frame 1205 to STA1 to request information regarding UL traffic buffered at STA1. STA1 may respond to BSRP frame 1205 by transmitting BSR frame 1210 to the AP that includes information regarding STA1’s UL transmission needs. The AP may then initiate downlink transmission by transmitting DL PPDU 1215 to STA1. DL PPDU 1215 may include an end of service period (EOSP) bit/flag that is set to a particular state (e.g., binary “1”) to signal that the AP has no more DL data to transmit during the current SP. STA1 may transmit BA frame 1220 (or other type of ACK frame) to the AP to acknowledge successful reception of DL PPDU 1215. The AP may then transmit trigger frame 1225 to STA1 to solicit UL transmission from STA1. Responsive to receiving trigger frame 1225, STA1 may transmit UL PPDU 1230 to the AP. UL PPDU 1230 may also include an EOSP bit/flag that is set to the particular state (e.g., binary “1”) to signal that STA1 has no more UL data to transmit during the current SP. The AP may transmit BA frame 1235 (or other type of ACK frame) to STA1 to acknowledge successful reception of UL PPDU 1230.

After the AP has confirmed that all scheduled transmissions (both in the DL and UL directions) have been successfully completed and that there is no further data to be exchanged during the current SP, the AP may broadcast a QoS null frame 1240 that includes an EOSP bit/flag that is set to a particular state (e.g., binary “1”) to explicitly signal that the SP is being terminated early. STA1 may transmit ACK frame 1245 to the AP to acknowledge successful reception of QoS null frame 1240. Upon receiving this QoS null frame 1240, non-member STAs that were deferring channel access during the SP may immediately begin contending for the channel, thus enabling a smooth and efficient transition from an exclusive r-TWT SP access scheme back to a standard contention-based access scheme.

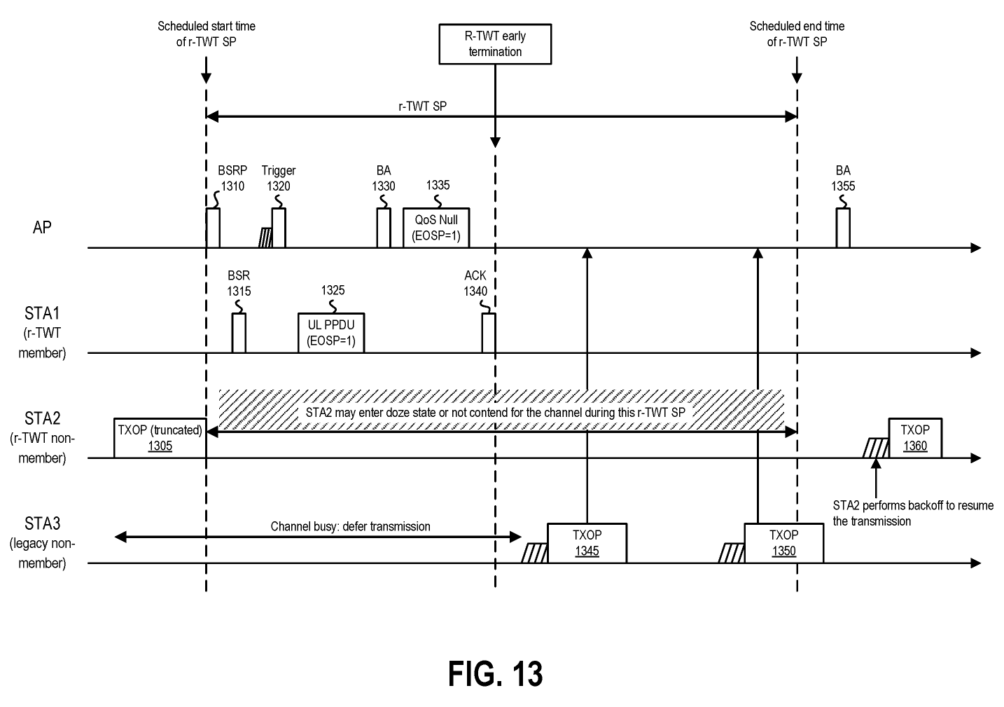

FIG. 13 is a diagram showing a frame exchange sequence where a non-member STA and a legacy STA access the channel after a SP is terminated early, according to some embodiments.

In the example shown in the diagram, it is assumed that STA1 is a member of a scheduled r-TWT SP. During the SP, the AP may transmit BSRP frame 1310 to STA1 to request information regarding UL traffic buffered at STA1. STA1 may respond to BSRP frame 1310 by transmitting BSR frame 1315 to the AP that includes information regarding STA1’s UL transmission needs. The AP may then transmit trigger frame 1320 to STA1 to solicit UL transmission from STA1. Responsive to receiving trigger frame 1320, STA1 may transmit UL PPDU 1325 to the AP. UL PPDU 1325 may include an EOSP bit/flag that is set to a particular state (e.g., binary “1”) to signal that STA1 has no more UL data to transmit during the current SP. The AP may then transmit BA frame 1330 (or other type of ACK frame) to STA1 to acknowledge successful reception of UL PPDU 1325. The AP may then broadcast QoS null frame 1335 that includes a EOSP bit/flag that is set to a particular state (e.g., binary “1”) to explicitly signal that the SP is being terminated early (before its originally scheduled end time). STA1 may respond by transmitting ACK frame 1340 to the AP.

Also, in this example, it is assumed that STA2 is a non-member STA of the current SP but is capable of recognizing the r-TWT schedule via beacon frames or other scheduling signals. As STA2 is considered to be a r-TWT scheduled STA, STA2 is required to pause/truncate any ongoing transmission activities or its TXOP 1305 before the start of the SP to avoid interference with the member STAs of the SP. STA2 may enter a doze state or not contend for the channel during the SP. If the SP is terminated early, STA2 may attempt to resume its deferred transmission or TXOP by re-accessing the channel via standard contention-based mechanisms such as random backoff. However, if STA2 is in a doze state, it may not be able to recognize the signal that the SP is being terminated early (e.g., miss QoS null frame 1335).

Also, in this example, it is assumed that STA3 is a legacy STA that does not support or recognize r-TWT schedules. STA3 may remain in an awake state regardless of SP activity. Once the early termination signal is transmitted, STA3 may detect that the channel is idle and initiate a transmission using standard CSMA/CA procedures. In this example, as shown in the diagram, it is assumed that STA3 is able to successfully acquire channel access rights shortly after the SP is early terminated and can transmit frames to the AP during TXOP 1345 and TXOP 1350. The AP may transmit BA frame 1355 to STA3 to acknowledge the uplink transmission. STA2 may then transmit during its TXOP 1360 (to resume TXOP 1305 that was truncated due to the SP starting) after performing backoff.

The behavior shown in the diagram introduces an unintended/undesirable consequence. Although STA2 is ready to resume transmission immediately after the early termination of the SP (it has data that it had to defer from transmitting due to the SP), it experiences additional delay because it must wait for STA3's transmission to complete before being able to access the channel. This situation highlights the challenges in maintaining channel fairness and minimizing transmission latency following early termination of the SP.

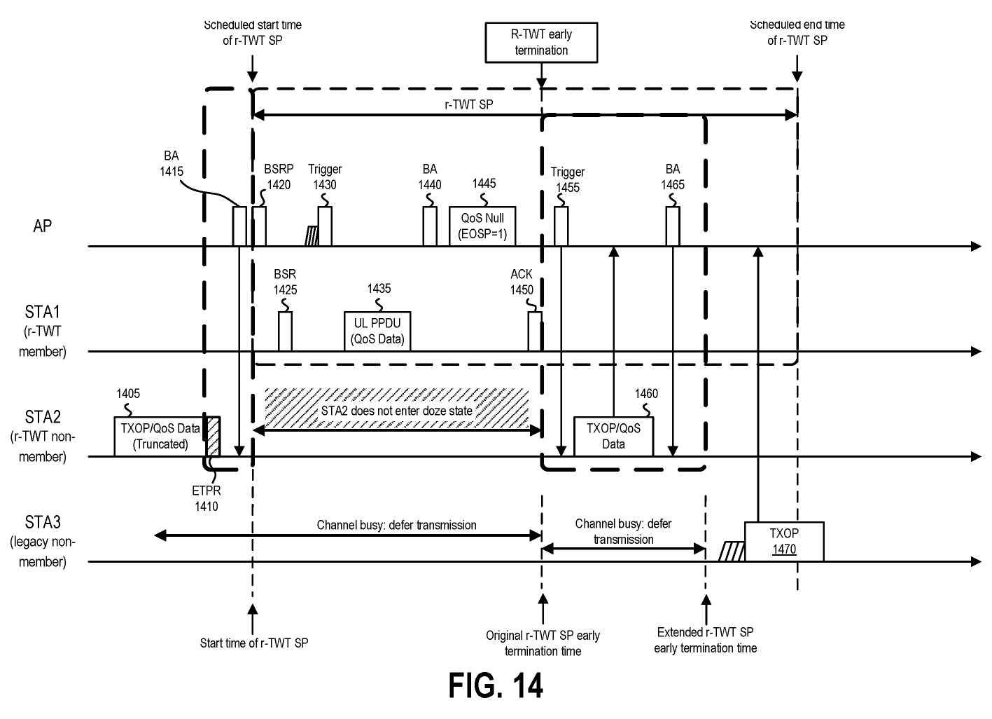

FIG. 14 is a diagram showing a frame exchange sequence for selectively reallocating the remaining duration of a SP after it has been terminated early, according to some embodiments.

The diagram shows an example of how the r-TWT framework can be enhanced to enable prioritized reallocation when a r-TWT SP is terminated early. In this example, the AP may retain control over the residual airtime following early termination of the SP. Rather than releasing the channel for general contention, the AP may selectively reallocate the remaining duration of the SP to a preselected STA based on priority criteria. This enables improved scheduling and QoS management in the wireless network.

In this example, it is assumed that STA2 is a non-member STA of the current SP but is capable of recognizing the r-TWT schedule. Prior to the start of the SP, STA2 may initiate TXOP 1405 but truncate/defer it before the SP begins. If STA2 wishes to resume its truncated/deferred transmission with minimal delay (e.g., to transmit latency-sensitive traffic), STA2 may request prioritized channel access in the event that the SP is terminated early. Such request may be referred to herein as an early termination priority request (ETPR). STA2 may convey this request by including an ETPR indication 1410 in in the QoS control field of the final QoS data frame or PS-Poll frame (or similar frame) that STA2 transmits during TXOP 1405 just before the SP begins. An ETPR indication 1410 may be encoded using a single bit/flag (e.g., by setting an ETRP bit/flat to binary “1”).

As a non-member STA of the SP, STA2 is not permitted to access the channel during the SP under existing r-TWT rules. ST2 may include ETPR indication 1410 in its transmission to proactively signal that it wishes to use any residual airtime that may become available if the SP is terminated early. This signaling approach avoids the need for having a separate control frame to request prioritized channel access, thereby reducing signaling overhead while still adhering to the existing protocol framework.

Upon recognizing ETPR indication 1410, the AP may evaluate the request (e.g., decide whether to give prioritized access to STA2) based on internal scheduling policies such as traffic urgency, latency requirements, and/or fairness criteria. The AP may then respond by transmitting BA frame 1415 to STA2 that includes an indication of whether STA2’s request has been accepted or denied. In this example, it is assumed that STA2’s request has been accepted and thus BA frame 1415 may include an early termination priority notification (ETPN) indication (not shown in the diagram) indicating that STA2 will be given channel access priority if the SP is terminated early.

In this example, since STA2’s request is accepted, STA2 may stay in the awake state throughout the SP despite not being a member of the SP so that it can promptly react to a potential reallocation of the remaining airtime in the event that the SP is terminated early. That is, STA2 does not enter a doze state during the SP despite not being a member of the SP.

In the example shown in the diagram, it is assumed that STA1 is a member of the current SP. Thus, the AP and STA1 exchange uplink and downlink frames during the SP. For example, during the SP, the AP may transmit BSRP frame 1420 to STA1 to request information regarding UL traffic buffered at STA1. STA1 may respond to BSRP frame 1420 by transmitting BSR frame 1425 to the AP that includes information regarding STA1’s UL transmission needs. The AP may then transmit trigger frame 1430 to STA1 to solicit UL transmission from STA1. Responsive to receiving trigger frame 1430, STA1 may transmit UL PPDU 1435 (which may include a QoS data frame) to the AP. The AP may then transmit BA frame 1440 (or other type of ACK frame) to STA1 to acknowledge successful reception of UL PPDU 1435. The AP may then broadcast QoS null frame 1445 that includes a EOSP bit/flag that is set to a particular state (e.g., binary “1”) to explicitly signal that the SP is being terminated early (before its originally scheduled end time).

Upon early termination of the SP, rather than releasing the channel for open contention, the AP may transmit trigger frame 1455 (e.g., after a short interframe space (SIFS) interval or arbitration interframe space (AIFS) interval after the SP is early terminated) to STA2 to grant STA2 channel access for some or all of the remaining duration of the originally scheduled SP. Responsive to receiving trigger frame 1455, STA2 may transmit uplink data frame 1460 (e.g., QoS data frame) to the AP, which may correspond to a transmission that was previously deferred due to the SP starting. The AP may acknowledge this uplink transmission by transmitting BA frame 1465 to STA2. STA3 may recognize the channel as being busy during this time and defer transmissions.

The AP may optionally repeat this priority reallocation process to allocate the remaining duration of the originally scheduled SP to other non-member STAs (e.g., by transmitting trigger frames to them) or conclude the prioritized reallocation process.

In this example, the time when STA1 finishes transmitting ACK frame 1450 represents the original SP early termination time and the time when the AP finishes transmitting BA frame 1465 to STA2 represents the extended SP early termination time. After this time, the channel becomes generally accessible, and legacy STAs such as STA3 may access the channel using standard CSMA/CA procedures. For example, STA3 may transmit a frame to the AP during TXOP 1470.

ETPR indication 1410 serves as a lightweight yet actionable scheduling hint that enables real-time and policy-aware resource reallocation to help improve uplink responsiveness in the wireless network. Embedding the ETPR indication 1410 in an existing field of an existing frame (e.g., in the QoS control field of a QoS data frame) provides a backward-compatible and low-overhead signaling pathway for dynamic STA coordination, particularly in dense, delay-sensitive environments. Such prioritized reallocation mechanism ensures deterministic and fair use of residual airtime, avoids collision risks associated with uncontrolled contention, and enhances responsiveness for delay-sensitive traffic.

To effectively implement prioritized reallocation after early termination, a control mechanism is needed to determine whether early termination is permitted for each individual SP. In particular, each SP should be configured with an SP early termination permission state that indicates whether early termination is permitted (enabled) or prohibited (disabled) for the SP. The scheduling AP may determine this state and communicate the state (along with other SP scheduling information) to its associated STAs through via broadcast beacon frames or negotiation signaling prior to the start of the SP.

When the early termination permission state for a SP is set to enabled, the AP may actively monitor the transmission progress of all member STAs of the SP. Upon detecting that all scheduled data exchanges have been successfully completed before the originally scheduled end time of the SP, the AP may broadcast an early termination signal to formally terminate the SP early. Immediately thereafter, the AP may initiate a prioritized reallocation of the remaining duration of the SP by transmitting one or more trigger frames to one or more preselected non-member STAs, as described earlier herein. These non-member STAs may have been chosen by the AP based on predefined criteria or scheduling policies such as latency sensitivity, buffered traffic urgency, and/or historical deferment records.

However, when the early termination permission state of a SP is set to disabled, the SP may proceed without interruption until its originally scheduled end time. In this case, the AP may suppress early termination signaling and refrain from reallocating the residual airtime, thereby preserving strict timing guarantees and maintaining compatibility with legacy or timing-critical deployments.

To support the prioritized reallocation functionality described herein, the AP may be equipped with a reallocation control module that is responsible for evaluating the early termination state, tracking transmission completions, and managing the prioritized reallocation process. This includes the dynamic selection and prioritization of eligible non-member STAs for trigger-based access to the residual airtime.

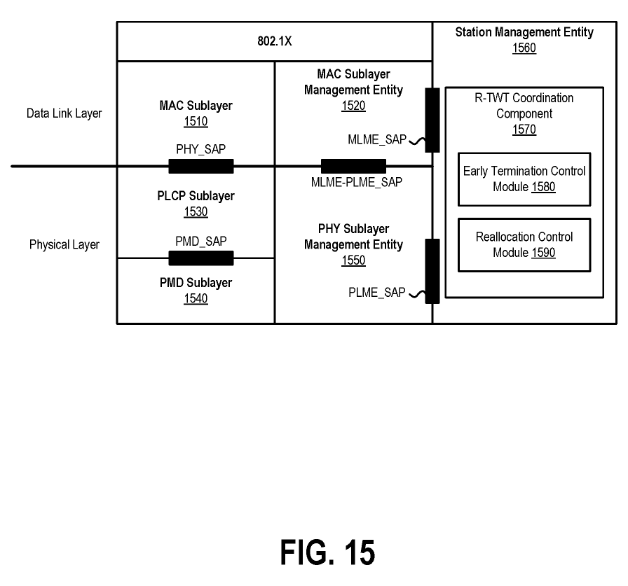

FIG. 15 is a diagram showing an architecture for implementing prioritized reallocation, according to some embodiments.

The diagram shows an architectural representation of how the prioritized reallocation mechanism can be implemented for the IEEE 802.11 protocol. The architecture includes a physical layer and a data link layer. The physical layer may include a physical medium dependent (PMD) sublayer 1540, a physical layer convergence protocol (PLCP) sublayer 1530, and a PHY sublayer management entity 1550. The data link layer may include a MAC sublayer 1510 and a MAC sublayer management entity 1520. The PHY_SAP may be an interface between the MAC layer and the PHY layer (specifically the PLCP sublayer 1530 to transfer user data (e.g., MPDUs). The PMD_SAP may be an internal PHY interface between the PLCP sublayer 1530 and the PMD sublayer 1540 to transfer data that is ready to be converted to physical radio frequency (RF) signals. The MLME_SAP may be a management interface between the SME 1560 and the MAC sublayer management entity (MLME) 1520 to handle MAC-level control commands (e.g., scanning, association, and authentication). The PLME_SAP may be a management interface between the SME 1560 and the PHY sublayer management entity (PLME) 1550 to handle PHY-level hardware control commands (e.g., changing radio channels or adjusting transmit power). The MLME-PLME_SAP may be an interface between the MAC sublayer management entity 1520 and the PHY sublayer management entity 1550 to coordinate management and control activities between the MAC and PHY layers.

The architecture may further include a station management entity (SME) 1560. The SME 1560 may manage the establishment, maintenance, and termination of wireless connectivity. In an embodiment, the SME 1560 is extended to include a r-TWT coordination component 1570 that manages various aspects of r-TWT operations.

The r-TWT coordination component 1570 may include an early termination control module 1580 and a reallocation control module 1590. The early termination control module 1580 may be responsible for determining whether early termination is permitted for a given r-TWT SP based on a configurable permission state (enabled/disabled). The reallocation control module 1590 may implement the prioritized reallocation functionality described herein to prioritize airtime reallocation to selected non-member STAs after a SP is terminated early.

This architectural extension may enable the SME 1560 to support one or more of the following functionalities: configuration of early termination permission (enabled/disabled) for each individual r-TWT SP; detection of early termination conditions such as when all member STAs complete their scheduled transmissions ahead of time; prioritized selection of non-member STAs for opportunistic access to the residual SP airtime using trigger-based signaling; generation and transmission of control and management frames, including QoS null frames and trigger frames to facilitate coordinated reallocation.

The reallocation control module 1590 may interface directly with the MAC sublayer 1510, MAC sublayer management entity (MLME) 1520, and the PHY service access point (SAP) to manage signaling and operational execution in line with the IEEE 802.11 framework.

A STA that is aware of an upcoming SP may perform an early termination priority request process when the STA prepares for an uplink TXOP. Before proceeding with the transmission, the STA may evaluate whether the TXOP end time would overlap with the start time of the SP. If the TXOP can be completed before the SP begins, the STA may proceed with normal transmission and no special behavior is required. However, if the TXOP is expected to extend into the SP, the STA may determine whether early termination is enabled for that particular SP. The early termination permission status of the SP may be provided in advance by the AP via scheduling information. If early termination is enabled for that particular SP, the STA may request prioritized reallocation (via an ETPR indication) before the SP begins.

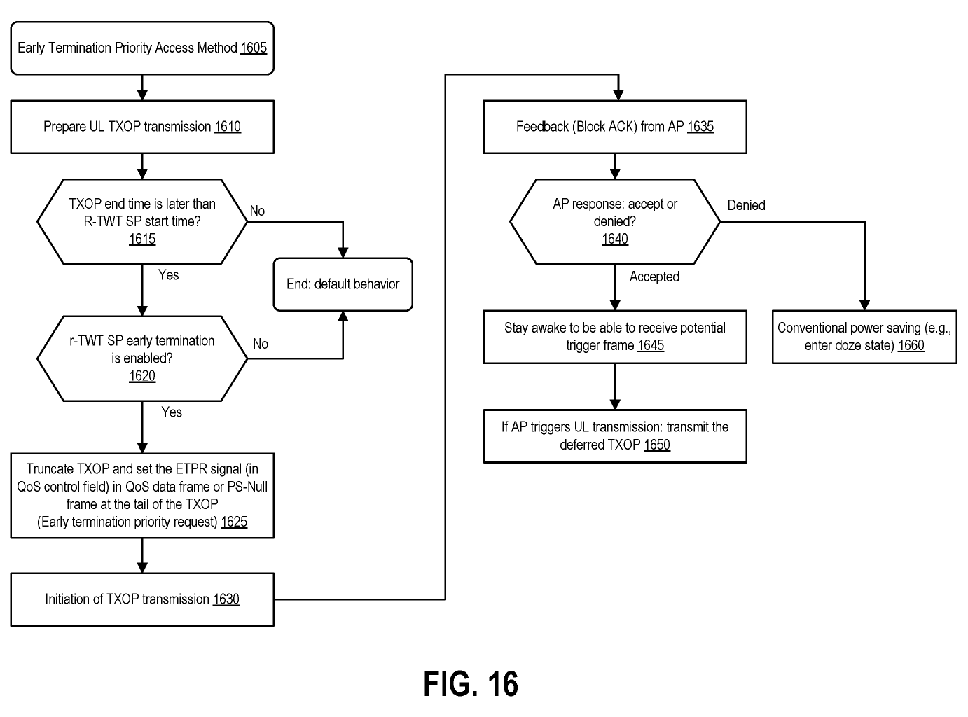

FIG. 16 is a flow diagram of an early termination priority access method that can be implemented by a non-member STA, according to some embodiments.

The method shown in the diagram represents the decision-making and request procedure performed by a non-member STA that is aware of an upcoming r-TWT SP. The objective of this procedure is to enable the STA to request prioritized access to any residual airtime of the SP in the event that the SP is terminated early, and to subsequently utilize that airtime for transmission.

As shown in the diagram, the early termination priority access method 1605 may begin at operation 1610, where the STA may prepare for an UL TXOP transmission. At operation 1615, the STA may determine whether the TXOP end time is later than the r-TWT SP start time. If the TXOP end time is not later than the r-TWT SP start time (i.e., the TXOP ends before the start of the r-TWT SP), the method 1605 may end (and the STA may proceed using the default behavior). Otherwise, if the TXOP end time is later than the r-TWT SP start time, the method 1605 may proceed to operation 1620. At operation 1620, the STA may determine whether r-TWT SP early termination is enabled. If r-TWT SP early termination is not enabled, the method 1605 may end (and the STA may proceed using the default behavior). The STA may defer its transmission or transition to a power-saving mode depending on the system design. Otherwise, if r-TWT SP early termination is enabled, the method may proceed to operation 1625. At operation 1625, the STA may truncate its TXOP (adjusts the TXOP to finish before the r-TWT SP begins) and set the ETPR signal (e.g., a bit/flag in a QoS control field) in the final QoS data frame or a separate PS-Null frame that is to be transmitted before the r-TWT SP begins (to request channel access priority if the r-TWT SP is terminated early). At operation 1630, the STA may initiate TXOP transmission, including transmission of the ETRP signal. At operation 1635, the AP may transmit feedback (e.g., in a BA frame) that includes an indication of whether the request for channel access priority has been accepted or denied. At operation 1640, the STA may determine whether the request has been accepted or denied. If the request is denied, the method may proceed to operation 1660, at which the STA may follow the default behavior (e.g., enter a doze state or refrain from channel access during the r-TWT SP). Otherwise, if the request is accepted, the method 1605 may proceed to operation 1645, at which the STA may stay awake during the r-TWT SP to be able to receive a potential trigger frame that would reallocate the residual airtime to the STA. If early termination occurs during the r-TWT SP, the AP may select the requesting STA as a candidate for prioritized reallocation. In such case, the AP may transmit a trigger frame to the STA to trigger UL transmission from the STA. At operation 1650, if the AP triggers UL transmission, the STA may resume its deferred transmission using the residual airtime without having to engage in standard contention-based channel access procedures.

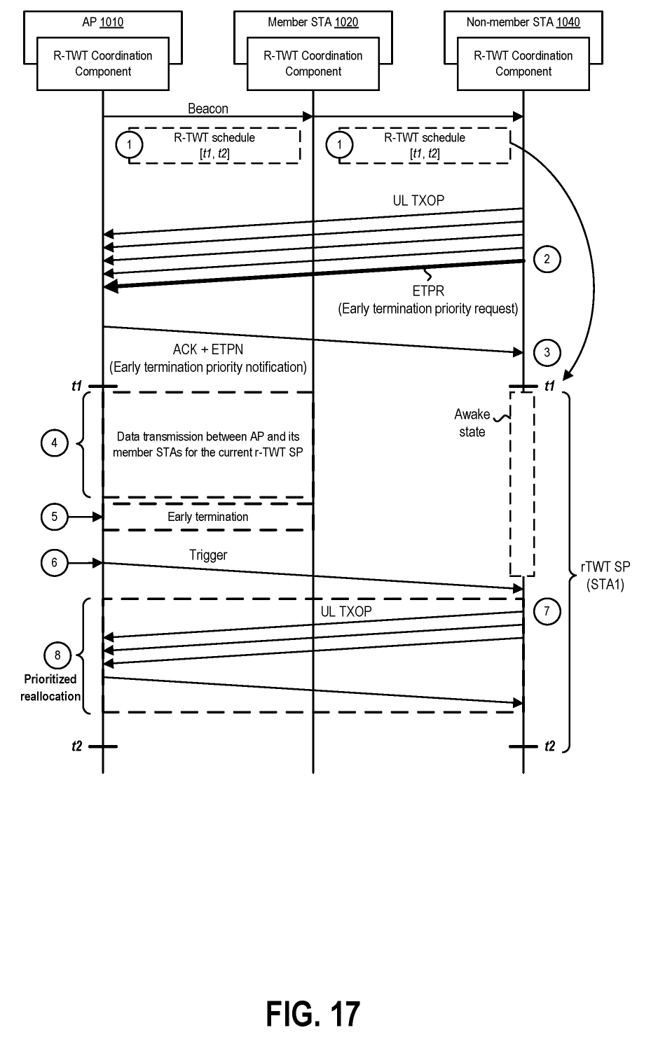

FIG. 17 is a diagram showing a signaling sequence for implementing a prioritized reallocation mechanism, according to some embodiments.

The signaling sequence shows an implementation of the prioritized reallocation mechanism following early termination of a r-TWT SP. The signaling sequence may involve an AP 1010, a member STA 1020, and a non-member STA 1040. The AP 1010, the member STA 1020, and the non-member STA may each implement a r-TWT coordination component that can implement respective functionalities of the prioritized reallocation mechanism.

In step 1, the AP may share the scheduling information for an upcoming r-TWT SP via a beacon frame. In this example, the r-TWT SP is scheduled to start at time t1 and end at time t2 (denoted in the diagram as [t1, t2]). This scheduling information may be shared with all associated STAs, including member STAs and non-member STAs.

In step 2, before the start time of r-TWT SP (before time t1), the non-member STA 1040 may evaluate its TXOP duration and determine that its TXOP will overlap with the scheduled r-TWT SP. Following the decision-making procedure described in FIG. 16, the non-member STA 1040 may truncate its TXOP to end before time t1 and transmit a QoS data frame or PS-Poll frame as the final transmission of the truncated TXOP. This frame may include a reserved bit in the QoS Control field that is set to indicate an ETPR. This ETPR indication may serve as an explicit signal to the AP to indicate the non-member STA’s 1040 intent to be considered for prioritized channel access to any residual airtime that may become available if the r-TWT SP is terminated early.

In step 3, in response to receiving the frame from the non-member STA 1040, the AP 1010 may transmit a block ACK frame that includes an indication of whether the request has been accepted or denied. In this example, it is assumed that the request has been accepted and thus the block ACK frame includes an ETPN indication indicating that the non-member STA 1040 will be given channel access priority if the r-TWT SP is terminated early.

In step 4, since the request was accepted, the non-member STA 1040 may remain in the awake state during the r-TWT SP instead of entering the doze state. Also, during the r-TWT SP (which starts at time t1), the AP 1010 and the member STAs of the r-TWT SP (e.g., including the member STA 1020) may perform a data frame exchange with each other.

In step 5, the AP and the member STAs may complete their transmission earlier than expected and the r-TWT SP may be terminated early (before time t2).

In step 6, upon detecting the early termination of the r-TWT SP, the AP 1010 does not release the channel for open/general contention, but instead transmits a trigger frame to the non-member STA 1040 after an inter-frame spacing (IFS) interval (e.g., SIFS or AIFS interval) to give the non-member STA 1040 prioritized channel access.

In step 7, upon receiving the trigger frame, the non-member STA 1040 may resume/initiate its deferred TXOP without having to participate in contention-based access procedure such as CSMA/CA.

In step 8, the non-member STA 1040 may continue exchange frames with the AP 1010 during the remaining duration of the originally scheduled r-TWT SP (e.g., until time t2). In this way, the non-member STA 1040 is given channel access priority to the remaining duration of the early-terminated r-TWT SP.

To support opportunistic and prioritized channel reassignment after early termination of a r-TWT SP, the disclosure introduces a novel signaling mechanism referred to as ETPR. The ETPR allows a non-member STA (a STA that is not scheduled to transmit during a given r-TWT SP) to request prioritized channel access to any residual airtime that may become available upon early termination of the r-TWT SP.

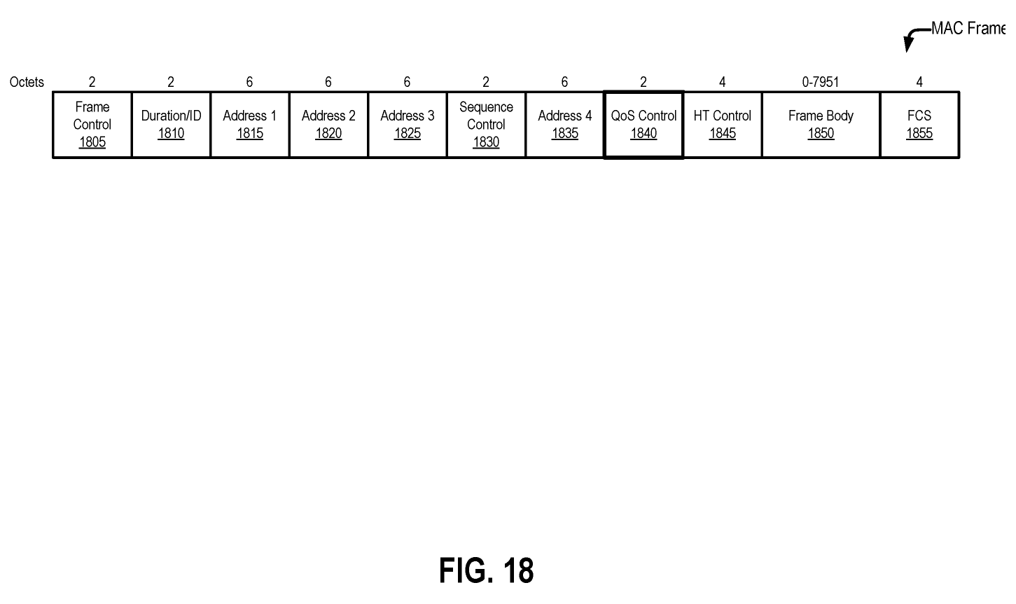

FIG. 18 is a diagram showing a MAC frame format, according to some embodiments.

As shown in the diagram, the MAC frame includes a frame control field 1805 (2 octets), a duration/ID field 1810 (2 octets), an address 1 field 1815 (6 octets), an address 2 field 1820 (6 octets), an address 3 field 1825 (6 octets), a sequence control field 1830 (2 octets), an address 4 field 1835 (6 octets), a QoS control field 1840 (2 octets), a HT control field 1845 (4 octets), a frame body 1850 (0 to 7951 octets), and a frame check sequence (FCS) field 1855 (4 octets).

The QoS control field may include sixteen (16) bits (i.e., 2 octets) with some of them currently being reserved for future use. In an embodiment, one of these currently reserved bits (e.g., bit 13 or bit 14) can be used as the ETPR flag/bit to indicate whether prioritized reallocation is being requested (e.g., setting the bit to binary “1” may indicate that prioritized reallocation is being requested, although the opposite convention is also possible). Embedding the ETPR indication in the QoS control field 1840 of a frame (e.g., a QoS data frame, QoS null frame, or PS-Poll frame) allows for a non-member STA to request prioritized access in a lightweight and backward-compatible manner that is compliant with the existing IEEE 802.11 wireless networking standards.

A non-member STA that intends to be considered for prioritized reallocation may set the ETPR bit/flag (e.g., set the corresponding bit to binary “1”) in its final QoS frame transmitted just before the r-TWT SP begins. Upon receiving such a frame, the AP may interpret the ETPR flag being set as a request for prioritized access in the event of early termination. The AP may determine whether to accept or reject the request based on internal scheduling policies, which may consider factors such as latency sensitivity, QoS class, and/or prior transmission deferral. If the request is accepted, the AP may transmit a trigger frame to the STA in the event that the r-TWT SP terminates early to allow the STA to use the remaining duration in the r-TWT SP (or at least a portion thereof), avoiding the need for contention-based access.

The prioritized reallocation mechanism described herein may offer a number of advantages. The ETPR signaling mechanism does not require introducing any new frame types and only adds minimal control logic, making it both practical and scalable to implement. By leveraging the existing QoS control field to carry the ETPR indication, the prioritized reallocation mechanism may facilitate efficient and policy-driven reallocation of channel resources, contributing to improved spectrum utilization and QoS support in wireless network environments.

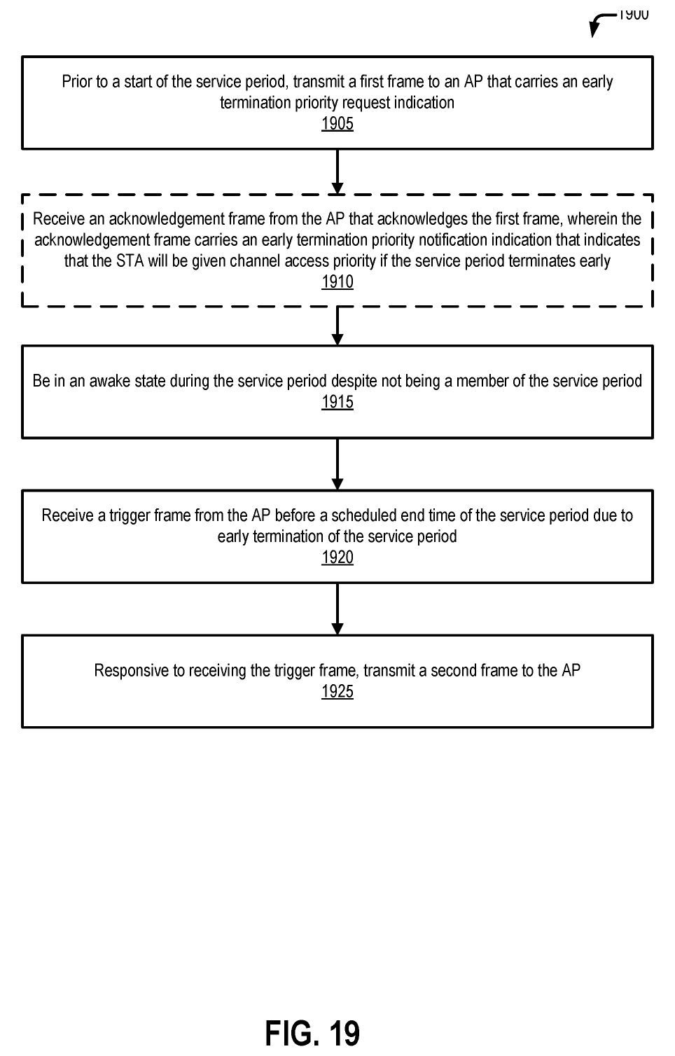

Turning now to FIG. 19, a method 1900 will be described for requesting channel access priority if a service period of a scheduled power saving scheme is terminated early, in accordance with an example embodiment. The method 1900 may be performed by a STA. The STA may be implemented by a wireless device (e.g., wireless device 104). In an embodiment, the scheduled power saving scheme is a r-TWT scheme.

At operation 1905, prior to a start of the service period, the STA transmits a first frame to an AP that carries an early termination priority request indication (ETPR indication). In an embodiment, the first frame is a QoS data frame or a PS-Poll frame. In an embodiment, the early termination priority request indication is carried in a QoS control field included in the first frame. For example, the early termination priority request indication may be carried in bit 13 or bit 14 of the QoS control field. In an embodiment, the early termination priority request indication is inserted into the first frame responsive to determining that early termination is enabled for the service period.

In an embodiment, at operation 1910, the STA receives an acknowledgement frame from the AP that acknowledges the first frame, wherein the acknowledgement frame carries an early termination priority notification indication (ETPN indication) that indicates that the STA will be given channel access priority if the service period terminates early.

At operation 1915, the STA is in an awake state during the service period despite not being a member of the service period.

At operation 1920, the STA receives a trigger frame from the AP before a scheduled end time of the service period due to early termination of the service period.

At operation 1925, responsive to receiving the trigger frame, the STA transmits a second frame to the AP. In an embodiment, the STA receives an acknowledgement frame from the AP that acknowledges the second frame.

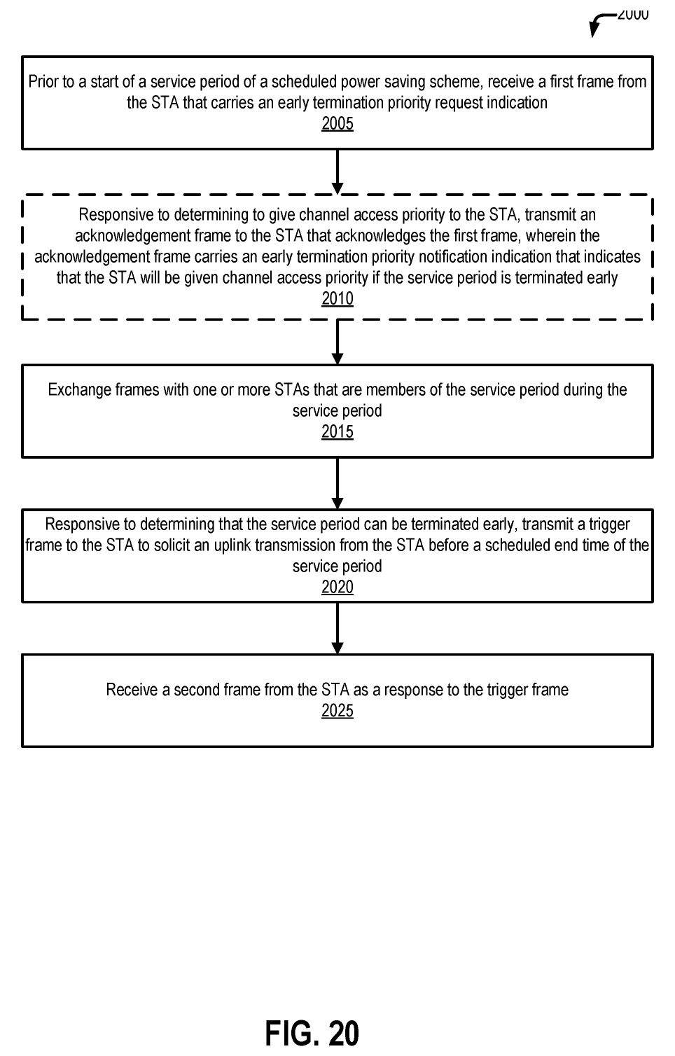

Turning now to FIG. 20, a method 2000 will be described for giving channel access priority to a non-member STA of a service period of a scheduled power saving scheme, in accordance with an example embodiment. The method 2000 may be performed by an AP (or other scheduling entity of the scheduled power saving scheme). The AP may be implemented by a wireless device (e.g., wireless device 104). In an embodiment, the scheduled power saving scheme is a r-TWT scheme.

At operation 2005, prior to a start of the service period, the AP receives a first frame from the STA (which is not a member of the service period) that carries an early termination priority request indication (ETPR indication). In an embodiment, the first frame is a QoS data frame or a PS-poll frame. In an embodiment, the early termination priority request indication is carried in a QoS control field included in the first frame. In an embodiment, the early termination priority request indication is carried in bit 13 or bit 14 of the QoS control field.

In an embodiment, responsive to receiving the early termination priority request indication, the AP determines whether to give channel access priority to the STA. Responsive to determining to give channel access priority to the STA, at operation 2010, the AP may transmit an acknowledgement frame to the STA that acknowledges the first frame, wherein the acknowledgement frame carries an early termination priority notification indication that indicates that the STA will be given channel access priority if the service period is terminated early.

At operation 2015, the AP exchanges frames with one or more STAs that are members of the service period during the service period.

At operation 2020, responsive to determining that the service period can be terminated early, the AP transmits a trigger frame to the STA to solicit an uplink transmission from the STA before a scheduled end time of the service period. In an embodiment, the determining that the service period can be terminated early is based on receiving one or more frames carrying an end of service period indication (EOSP indication) from the one or more (member) STAs. In an embodiment, the AP transmits, during the service period, a second frame that carries an end of service period indication that indicates that the service period is being terminated early. In an embodiment, the second frame (that carries the end of service period indication) is a QoS null frame that is broadcasted.

At operation 2025, the AP receives a second frame from the STA as a response to the trigger frame. In an embodiment, the AP transmits an acknowledgement frame to the STA that acknowledges the second frame. In an embodiment, after receiving the second frame from the STA, the AP transmits a second trigger frame to a second STA to solicit an uplink transmission from the second STA, wherein the second STA is not a member of the service period but has transmitted an early termination priority request indication to the AP prior to the start of the service period. The AP may then receive a third frame from the second STA as a response to the second trigger frame.

In an embodiment, prior to the start of the service period, the AP transmits an indication that early termination is permitted for the service period.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a station (STA) that is not a member of a service period of a scheduled power saving scheme to receive channel access priority if the service period is terminated early, the method comprising:
prior to a start of the service period, transmitting a first frame to an access point (AP) that carries an early termination priority request indication;
being in an awake state during the service period despite not being a member of the service period;
receiving a trigger frame from the AP before a scheduled end time of the service period due to early termination of the service period; and
responsive to receiving the trigger frame, transmitting a second frame to the AP.

2. The method of claim 1, further comprising:
receiving an acknowledgement frame from the AP that acknowledges the first frame, wherein the acknowledgement frame carries an early termination priority notification indication that indicates that the STA will be given channel access priority if the service period terminates early.

3. The method of claim 1, further comprising:
receiving an acknowledgement frame from the AP that acknowledges the second frame.

4. The method of claim 1, wherein the early termination priority request indication is inserted into the first frame responsive to determining that early termination is enabled for the service period.

5. The method of claim 1, wherein the first frame is a quality of service (QoS) data frame or a power save poll (PS-poll) frame.

6. The method of claim 5, wherein the early termination priority request indication is carried in a quality of service (QoS) control field included in the first frame.

7. The method of claim 6, wherein the early termination priority request indication is carried in bit 13 or bit 14 of the QoS control field.

8. The method of claim 1, wherein the scheduled power saving scheme is a restricted target wake time (r-TWT) scheme.

9. A method performed by an access point (AP) to give channel access priority to a station (STA) that is not a member of a service period of a scheduled power saving scheme if the service period is terminated early, the method comprising:
prior to a start of a service period of a scheduled power saving scheme, receiving a first frame from the STA that carries an early termination priority request indication;
exchanging frames with one or more STAs that are members of the service period during the service period;
responsive to determining that the service period can be terminated early, transmitting a trigger frame to the STA to solicit an uplink transmission from the STA before a scheduled end time of the service period; and
receiving a second frame from the STA as a response to the trigger frame.

10. The method of claim 9, further comprising:
responsive to receiving the early termination priority request indication, determining whether to give channel access priority to the STA; and
responsive to determining to give channel access priority to the STA, transmitting an acknowledgement frame to the STA that acknowledges the first frame, wherein the acknowledgement frame carries an early termination priority notification indication that indicates that the STA will be given channel access priority if the service period is terminated early.

11. The method of claim 9, wherein the determining that the service period can be terminated early is based on receiving one or more frames carrying an end of service period indication from the one or more STAs.

12. The method of claim 9, further comprising:
transmitting an acknowledgement frame to the STA that acknowledges the second frame.

13. The method of claim 9, further comprising:
prior to the start of the service period, transmitting an indication that early termination is permitted for the service period.

14. The method of claim 9, wherein the first frame is a quality of service (QoS) data frame or a power save poll (PS-poll) frame.

15. The method of claim 14, wherein the early termination priority request indication is carried in a QoS control field included in the first frame.

16. The method of claim 15, wherein the early termination priority request indication is carried in bit 13 or bit 14 of the QoS control field.

17. The method of claim 9, further comprising:
after receiving the second frame, transmitting a second trigger frame to a second STA to solicit an uplink transmission from the second STA, wherein the second STA is not a member of the service period but transmitted an early termination priority request indication to the AP prior to the start of the service period; and
receiving a third frame from the second STA as a response to the second trigger frame.

18. The method of claim 9, further comprising:
transmitting, during the service period, a second frame that carries an end of service period indication that indicates that the service period is being terminated early.

19. The method of claim 18, wherein the second frame is a quality of service (QoS) null frame that is broadcasted.

20. The method of claim 9, wherein the scheduled power saving scheme is a restricted target wake time (r-TWT) scheme.

21. A wireless device to function as a station (STA) in a wireless network, the wireless device comprising:
a radio frequency transceiver;
a memory device storing a set of instructions; and
a processor coupled to the memory device, wherein the set of instructions, when executed by the processor, causes the STA to:
prior to a start of a service period of a scheduled power saving scheme, transmit a first frame to an access point (AP) that carries an early termination priority request indication;
be in an awake state during the service period despite not being a member of the service period;
receive a trigger frame from the AP before a scheduled end time of the service period due to early termination of the service period; and
responsive to receiving the trigger frame, transmit a second frame to the AP.
